(19) United States
(12) Patent Application Publication
(10) Pub. No.: US 2006/0255320 A1
(43) Pub. Date: Nov. 16, 2006

(54) Novel polymeric hindered amine light stabilizers based on end functionalized polyolefins and a process for the preparation thereof

(75) Inventors: Kummetha Raghunatha Reddy, Pune (IN); Singh Raj Pal, Pune (IN)

Correspondence Address: DLA PIPER RUDNICK GRAY CARY US, LLP, 4365 EXECUTIVE DRIVE, SUITE 1100, SAN DIEGO, CA, 92121-2133, US

(73) Assignee: COUNCIL OF SCIENTIFIC & INDUSTRIAL RESEARCH, Rafi Marg (IN)

(21) Appl. No.: 11/395,538

(22) Filed: Mar. 30, 2006

(30) Foreign Application Priority Data
Mar. 31, 2005 (IN) 797/DEL/2005

(51) Int. Cl. C09K 15/00

(52) U.S. Cl. 252/397

(57) ABSTRACT

The present invention relates to a light stabilizer of general formula 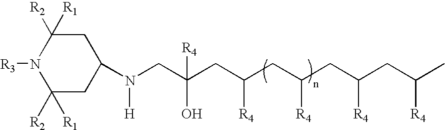
Where in, and R₁ is methyl or hydrogen, R₂ is C₁ to C₄ alkyl chains and R₃ is selected from the group consisting of C₁-C₈ alkyl, alkyl phenyl and alkyloxy chain and R₄ is C₁ to C₈ alkyl chain. More.

### FIELD OF THE INVENTION

The present invention relates to novel polymeric hindered amine light stabilizers (PHALS) of Formula (1) based on functionalized polyolefin and a process for preparation thereof. 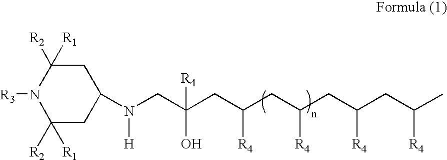
Wherein, R₁ is methyl or H, R₂ is C₁ to C₄ alkyl chain and R₃ is selected from the group consisting of C₁-C₈ alkyl, alkyl phenyl and alkyloxy chain and R₄ is C₁-C₈ alkyl chain. More particularly, the said PHALS of formula 1 is based on end functionalized polypropylene prepared by using of epoxy terminated polypropylene oligomers of Formula (2). 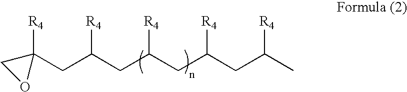
Wherein R₄ is C₁-C₈ alkyl chains, where the above epoxy end-functionalized (Formula (2)) prepared by using vinylidine-terminated polypropylene of Formula (3). 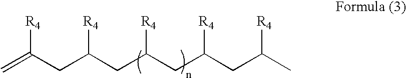
wherein R₄ is C₁-C₈ alkyl chains, where the said PHALS Formula (1) is prepared by reacting the formula 2 with 4-amino-2,2,6,6-tetramethyl piperidine containing general Formula (4). 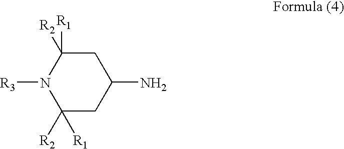
wherein R₁ is methyl or H, R₂ is C₁ to C₄ alkyl chain and R₃ is selected from the group consisting of C₁-C₈ alkyl, alkyl phenyl and alkyloxy chain.

### BACKGROUND OF THE INVENTION

Polymer materials exposed to sunlight or used at elevated temperatures or even stored at room temperature in presence of air undergo degradation, which shortens their service life; the former is associated with photooxidation, and the latter is mainly a consequence of thermal oxidation. These all may lead to deteriorate polymer properties like mechanical properties, impact strength and modulus etc. There are several ways to prevent thermal oxidation and photooxidation of polymers: Addition of stabilizers (antioxidants and light stabilizers) is still the most convenient and effective way as this addition will not alter processing conditions to any significant extent and there are many effective stabilizers to serve this purpose.

For outdoor use, hindered amine light stabilizers (HALS) are often added in order to prevent photodegradation of plastics, paints and textiles. The addition of polymeric HALS to polymers is used frequently due to their lower leach-out from the substrate materials. It is well known that Hindered Amine Light Stabilizers (HALS) are very effective. However, HALS with low molecular weights are relatively volatile at processing temperatures and easily extracted by liquids. A new trend in the development of light stabilizer is to prepare HALS with higher molecular weight. Copolymerization of functional monomers containing hindered amine is one method for preparing HALS with higher molecular weight. Synthesis of several polymeric HALS has been reported, many of them are based on derivatives of 2,2,6,6-tetramethyl-4-piperidene. Alkylated piperidine derivatives U.S. Pat. Nos. 4,234,734 and 4,316,837 and copolymers of piperidine with olefin monomers U.S. Pat. No. 5,990,209 are included as references. Homogeneous metallocene catalyzed polyolefins have controlled molecular structure and narrow molecular weight distribution. The β-hydrogen elimination from growing chain to monomer/solvent/co-catalyst leads to form vinylidene-terminated polyolefins, which can be functionalized via simple organic reactions to get end-functionalized polyolefins.

The use of low molecular weight (LMW) HALS compounds may not be compatible with hydrophobic polymers and also may not disperse properly because of one or more polar groups present in them. LMW compounds can migrate easily to the liquids particularly application like fiber, packaging and paints. U.S. Pat. No. 4,413,096 disclose the preparation of olefin copolymers containing pendent hindered amine groups. The drawbacks of polar HALS copolymers exhibit poor dispersions with hydrophobic polyolefin polymers.

Wilen et al (Journal of polymer Science Part A. Poly Chem. 1992, 1163) synthesized copolymers containing hindered piperidine groups with propylene via Ziegler Natta polymerization. The disadvantage of this method was the polar groups in piperidine, which might act as poison for the catalyst and ultimately lead to give low yields of polymerization and less insertion of comonomer.

Wilen et al. (Macromolecules 2000, 33,5501) synthesized copolymers based on alkylated piperidine derivatives with ethylene and propylene. The drawbacks of the method are the comonomers based on HALS may poise the metallocene catalyst and the incorporation of comonomer will be very less.

Mani et al. (Polymer 1997, 38,1739) have prepared HALS end functionalized poly(ethylene-alt-propylene) copolymer by terminating anionic living polymerization of isoprene with 4-(2,3-epoxypropoxy)-1,2,2,6,6-pentamethylpiperidine followed by hydrogenation. The drawback of this method was the long route of synthesis and expensive.

Auer et al. (Journal of polymer Science Part A: Polymer Chemistry 2004, 42,1350) synthesized polymerizable hindered amine light stabilizer monomers for transition metal catalyzed olefin copolymerization with long aliphatic chain. The drawbacks of this method are the increase in feed ratio of monomer and decrease in catalyst activity.

Some preferred metallocene catalysts for the synthesis of vinylidine terminated polyolefins are bis(cyclopentadienyl) zirconiumdichloride, dimethyl bis(cyclopentadienyl)zirconium dichloride, bis(methylcyclopentadienyl)zirconium chloride and dimethylsilyl dicyclopentadienyl chloride. The co-catalysts, which may be used, are alumoxanes, which may be in the form of oligomers or cyclic alumoxanes. The alumoxanes may be prepared by contacting water with a solution of aluminum trialkyls in suitable organic solvents. The mole ratio of aluminum in an alumoxane to total metal content in the catalysts may be employed in the range of 20:1 to 5000:1. The solvents used in the preparation of the catalyst system are inert hydrocarbons. The solvent should be inert to the catalyst system, such solvents are hexane, octane, toluene, xylene and cyclohaxane. The polymerizations are usually conducted at the temperatures in the range of 20-100° C. and reaction time is for few hours and it is not critical. The usual pressure employed at range of 1-2000 atmosphere. After polymerization, the catalyst was deactivated by adding acidified methanol. The low molecular weight polyolefins having vinylidine unsaturation can react easily as compared to high molecular weight polyolefins having vinylidine unsaturation. The polyolefin based polymeric stabilizer of this invention may be used as stabilizer for hydrophobic polyolefins. It may be melt blended with the polymers at sufficient levels to impart stability to the polymer matrix. The quantity of the stabilizer to be used in the polymer matrix depends upon the molecular weight of the polymer and the higher molecular weight polymers will have less quantity of HALS groups and vice versa. The optimum molecular weight of the polymers used in this is in the range of 1000 to 5000. This polymeric stabilizer may be blended with polymer matrix by any known technique, which provides good mixing.

In our previous patents U.S. Pat. No. 6,489,482 B2 and U.S. Pat. No. 6,737,528 B2 described the novel vinylic hindered amine stabilizers and process for the preparation thereof. The limitation of these stabilizers, are need extra processing step where to anchor them on the surface of the polymer substrate. But the present stabilizers which can be melt compounded with other additives and may disperse evenly the polymer matrix due long hydrophobic polyolefin chain.

It is known that the polyalkylpiperidine radical is effective as light stabilizer for synthetic polymers. Monomeric and low molecular weight absorbers are having limitations owing to their properties of migration and leaching. This phenomenon could lead uneven distribution of UV absorbers within polymer matrix. Leaching of a light stabilizer may cause sever problem to polymer matrix that could lead to extensive photo degradation. Therefore, in order to prevent the phenomena of migration and leaching, the light stabilizers having higher molecular weight (having long hydrocarbon chain) are being developed. This class of light stabilizers would have even distribution within the polymer matrix and also they overcome the phenomena of leaching and migration.

In this invention, olefin polymers containing terminal unsaturation are characterized up to above 95% of vinylidene unsaturation at the chain ends. The terminal unsaturated polymers and the composition employed in this invention may be prepared as described in U.S. Pat. No. 6,117,962.

### OBJECTIVES OF THE INVENTION

The main object of the present invention is to provide novel end functionalized polypropylene hindered amine light stabilizers.

Yet another object is to provide novel end functionalized polypropylene hindered amine light stabilizers with high functionality of chain ends having hindered amine group.

Yet another object is to provide a class of PHALS which may be compatible with polyolefins, polystyrene, elastomers and more particularly in fiber applications and can be added in an additive portion to obtain desired photo-stability of various other polymers also.

Yet another object is to provide a process for the preparation of novel end functionalized polypropylene hindered amine light stabilizers with high functionality of chain ends having hindered amine group.

### SUMMARY OF THE INVENTION

The present invention provides novel polymeric hindered amine light stabilizers of Formula (1), 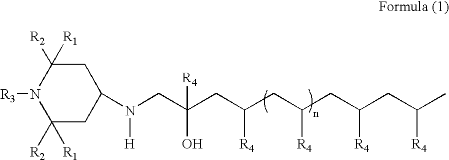
Wherein R₁ is methyl or H, R₂ is C₁ to C₄ alkyl chain and R₃ is selected from the group consisting of C₁-C₈ alkyl, alkyl phenyl and alkyloxy chain and R₄ is C₁-C₈ alkyl chain. 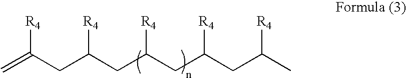
Compound of formula (3) is epoxide to obtain a compound of formula (2); 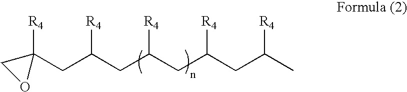
wherein R₄ is C₁-C₈ alkyl chain, subsequently the compound of formula (2) is reacted with a compound of formula (4) in an organic solvent, at a temperature in the range of 70-120° C., at an ambient pressure, for a period of 24-36 hrs followed by washing the resultant mixture with water and drying at 30-60° C. temperature under vacuum to obtain compound of formula (1).

### DETAIL DESCRIPTION OF THE INVENTION

Accordingly the present invention provides a novel poly hindered amine light stabilizer having the formula 1 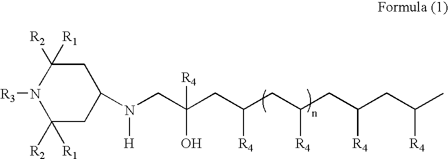
wherein R₁ is methyl or hydrogen, R₂ is C₁ to C₄ alkyl chain and R₃ is selected from the group consisting of C₁-C₈ alkyl, alkyl phenyl and alkyloxy chain and R₄ is C₁ to C₈ alkyl chain.

In an embodiment of the present invention the poly hindered amine light stabilizer obtained is selected from 4-amino-2,2,6,6-tetramethyl piperidine end functionalized polypropylene and 4-amino-2,2,6,6-tetramethyl piperidine end functionalized poly (hexene1)

In yet another embodiment the poly hindered amine light stabilizer obtained is selected from N-(2-hydroxypoly (propenyl)-(2,2,6,6-tetramethylpiperidinyl) amine having Mw1500 and N-(2-hydroxypoly(propenyl)-(2,2,6,6-tetramethyl piperidinyl) amine having Mw 2200. The present invention further provides a process for the preparation of polymeric hindered amine light stabilizer (PHALS) having the formula 1 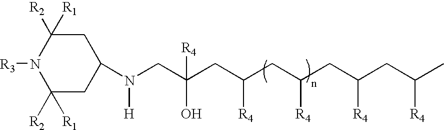
wherein, and R₁ is methyl or hydrogen, R₂ is C₁ to C₄ alkyl chain and R₃ is selected from the group consisting of C₁-C₈ alkyl, alkyl phenyl and alkyloxy chain and R₄ is C₁ to C₈ alkyl chain which comprises
reacting m-chloroperbenzoic acid with a compound of formula (3) 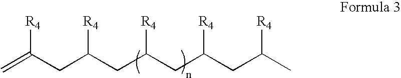
wherein R₄ is C₁-C₈ alkyl chain, in an organic solvent, at a temperature in the range of 20-40° C., for a period of 16-24 hrs, neutralizing the resultant mixture with a saturated weak alkali sodium bicarbonate solution followed by purification and drying under vacuum by known method to obtain the compound of formula 2 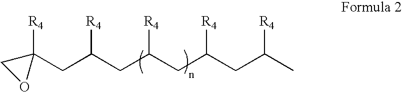
wherein R₄ is C₁-C₈ alkyl chain, reacting the above said compound of formula 2 with a hindered amine light stabilizer of formula 4 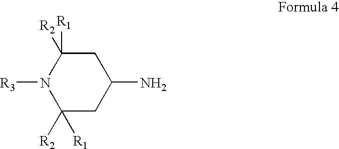
wherein R₁ is methyl or H, R₂ is C₁ to C₄ alkyl chain and R₃ is selected from the group consisting of C₁-C₈ alkyl, alkyl phenyl and alkyloxy chain, in an organic solvent, at a temperature in the range of 60-120° C., for a period of 24-36 hrs, washing the resultant mixture with water and drying at a temperature of 30-60° C. under vacuum to obtain the desired compound of formula (1).

In yet another embodiment the compound of formula 3 used is having at least 10% terminal unsaturation and is selected from crystalline and amorphous homopolymers having Mn in the range of 500 to 20,000 and crystalline and amorphous copolymers of C₂ to C₈ mono olefins having Mₙ in the range of 500 to 20,000.

In yet another embodiment the compound of formula 3 used is selected from terminally unsaturated poly (propylene), terminally unsaturated poly (hexene1) and copolymer of ethylene and polypropylene.

In yet another embodiment the compound of formula 3 used is selected from terminally unsaturated poly (propylene) having the number average molecular weight (Mn) of 1500 and unsaturated poly (propylene) having the number average molecular weight (Mn) of 2200.

In yet another embodiment the compound of formula 2 used is selected from epoxy end functionalized crystalline and amorphous homopolymers having Mn in the range of 500 to 20,000 and epoxy end functionalized crystalline and amorphous copolymers of C₂ to C₈ mono olefins having Mₙ in the range of 500 to 20,000.

In yet another embodiment the compound of formula 2 used is selected from epoxy end functionalized polypropylene and epoxy end functionalized poly (hexene1) and epoxy end functionalized copolymer of ethylene and polypropylene.

In yet another embodiment the compound of formula 2 used is selected from epoxy end functionalized polypropylene having Mn 1500 and epoxy end functionalized polypropylene having Mn 2200.

In yet another embodiment the organic solvent used in the conversion of the compound of formula 2 to compound of formula 3 is chloroform.

In yet another embodiment the hindered amine light stabilizer of formula 4 used is 4-amino-2,2,6,6-tetramethyl piperidine.

In yet another embodiment the organic solvent used in the reaction of the compound of formula 2 with a HALS compound of formula 4 is selected from the group consisting of hydrocarbon and halogenated hydrocarbon.

In yet another embodiment the organic solvent used in the reaction of the compound of formula 2 with a HALS compound of formula 4 is selected from the group consisting of hexane, heptane, and p-chlorobenzene.

In yet another embodiment the poly hindered amine light stabilizer obtained is selected from 4-amino-2,2,6,6-tetramethyl piperidine end functionalized polypropylene and 4-amino-2,2,6,6-tetramethyl piperidine end functionalized poly (hexene1).

In yet another embodiment the poly hindered amine light stabilizer obtained is selected from N-(2-hydroxypoly (propenyl)-(2,2,6,6-tetramethyl piperidinyl) amine having Mw1500 and N-(2-hydroxypoly(propenyl)-(2,2,6,6-tetramethyl piperidinyl) amine having Mw 2200.

The following examples are given by the way of illustration and should not be construed to limit the scope of the invention.

### EXAMPLE 1

Synthesis of Epoxy End Functionalized Polypropylene (Mn=2200)

This example illustrates, terminally unsaturated poly(propylene) used was produced by using the metallocene/alumoxane catalyst system. The number average molecular weight (Mn) of polymer is 2200 and the terminal vinylidine unsaturation of the polymer is more than 95%.

In a dry 250 ml two necked round bottom flask equipped with stirrer and nitrogen inlet, 15 gms (6.8 m mol.) of the terminally unsaturated polypropylene and 100 ml chloroform solvent to form a solution were added. To this solution 2.7 equivalents 3.16 gms (18.3 m mol.) of m-chloroperbenzoic acid was added and stirred the mixture for 24 hrs at ambient temperature. The epoxidised polymer was obtained by repeated washing of the reaction mixture with sodium bicarbonate and water solution and the product was dried. The product was purified by dissolving it in hexane and dried over on an anhydrous magnesium sulphate and vacuum dried in oven at 60° C.

The product was characterized by ¹H NMR and the percentage of functionalization was calculated with the help of number average molecular weight determined by Vapor Phase Osmometry and found to be 80%.

### EXAMPLE 2

Synthesis of Epoxy End Functionalized Polypropylene (Mn=1500)

This example illustrates terminally unsaturated poly(propylene) used was produced by using the metallocene/alumoxane catalyst system. The number average molecular weight (Mn) of polymer is 1500 and the terminal vinylidine unsaturation of the polymer is more than 95%.

In a dry 250 ml two necked round bottom flask equipped with stirrer and nitrogen inlet 6.8 m mol. of the terminally unsaturated polypropylene and 100 ml chloroform solvent to form a solution were added. To this solution 2.7 equivalents (18.3 m mol.) of m-chloroperbenzoic acid was added and stirred the mixture for 24 hrs at ambient temperature. The epoxidised polymer was obtained by repeated washing of the reaction mixture with sodium bicarbonate and water solution and the product was dried. The product was purified by dissolving it in hexane and dried over on an anhydrous magnesium sulphate and vacuum dried in a vacuum oven at 60° C.

The product was characterized by ¹H NMR and the percentage of functionalization was calculated with the help of number average molecular weight determined by Vapor Phase Osmometry and found to be 80%.

### EXAMPLE 3

Synthesis of HALS End Functionalized Polypropylene (Mn=1500)

This example illustrates, end epoxy functionalized polypropylene reacted with 4-amino 2,2,6,6-teramethyl piperidine. To a 200 ml two necked round bottom flask equipped with condenser and a nitrogen inlet 10 grams (4.5 mmol.) of epoxidised polypropylene and 1.2 equivelents 1.5 grams (9 m mol) of 4-amino 2,2,6,6-teramethyl piperidine and hexane as solvent were added. The hexane (solvent) was dried over sodium wire and added. This reaction was carried out for 24 hrs at 70° C. The hexane solution precipitated repeated times in methanol to get above mention hindered amine polymeric light stabilizer.

The compound was characterized by ¹H NMR and the percentage of functionalization was calculated with the help of number average molecular weight determined by Vapor Phase Osmometry and found to be around 85%.

### EXAMPLE 4

Synthesis of HALS End Functionalized Polypropylene (Mn=2200)

This example illustrates, end epoxy functionalized polypropylene reacted with 4-amino 2,2,6,6-teramethyl piperidine. To a 200 ml two necked round bottom flask equipped with condenser and a nitrogen inlet 4.5 m mol. of epoxidised polypropylene and 1.2 equivelents (9 m mol) of 4-amino 2,2,6,6-teramethyl piperidine and hexane as solvent were added. The hexane (solvent) was dried over sodium wire and added. This reaction was carried out for 24 hrs at 70° C. The hexane solution precipitated repeated times in methanol to get above mention hindered amine polymeric light stabilizer.

The compound was characterized by ¹H NMR and the percentage of functionalization was calculated with the help of number average molecular weight determined by Vapor Phase Osmometry and found to be around 85%.

The advantages of present invention are:

1. The process comprises of commonly used organic reagents and with high functionality.
2. This compound may be dispersing uniformly in the polymer matrix, when compared to other existed stabilizers because of long hydrophobic chain.

1. A poly hindered amine light stabilizer having the formula 1 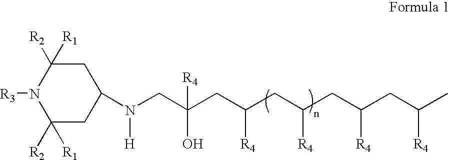
wherein R₁ is methyl or hydrogen, R₂ is C₁ to C₄ alkyl chain and R₃ is selected from the group consisting of C₁-C₈ alkyl, alkyl phenyl and alkyloxy chain and R₄ is C₁ to C₈ alkyl chain.

2. A poly hindered amine light stabilizer according to claim 1 is selected from 4-amino-2,2,6,6-tetramethyl piperidine end functionalized polypropylene and 4-amino-2,2,6,6-tetramethyl piperidine end functionalized poly (hexene1).

3. A poly hindered amine light stabilizer according to claim 1 is selected from N-(2-hydroxypoly (propenyl)-(2,2,6,6-tetramethyl piperidinyl) amine having Mw1500 and N-(2-hydroxypoly(propenyl)-(2,2,6,6-tetramethyl piperidinyl) amine having Mw 2200.

4. A process for the preparation of polymeric hindered amine light stabilizer (PHALS) having the formula 1 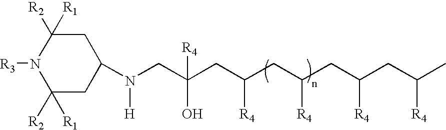
wherein, and R₁ is methyl or hydrogen, R₂ is C₁ to C₄ alkyl chain and R₃ is selected from the group consisting of C₁-C₈ alkyl, alkyl phenyl and alkyloxy chain and R₄ is C₁ to C₈ alkyl chain which comprises
reacting m-chloroperbenzoic acid with a compound of formula (3) 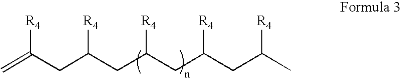
wherein R₄ is C₁-C₈ alkyl chain, in an organic solvent, at a temperature in the range of 20-40° C., for a period of 16-24 hrs, neutralizing the resultant mixture with a saturated weak alkali 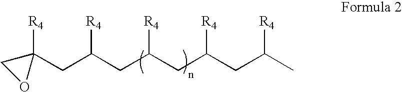
sodium bicarbonate solution followed by purification and drying under vacuum by known method to obtain the compound of formula 2
wherein R₄ is C₁-C₈ alkyl chain, reacting the above said compound of formula ₂ with a hindered amine light stabilizer of formula 4 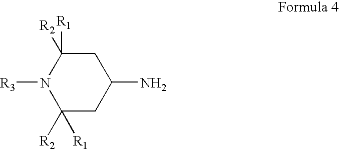
wherein R₁ is methyl or H, R₂ is C₁ to C₄ alkyl chain and R₃ is selected from the group consisting of C₁-C₈ alkyl, alkyl phenyl and alkyloxy chain, in an organic solvent, at a temperature in the range of 60-120° C., for a period of 24-36 hrs, washing the resultant mixture with water and drying at a temperature of 30-60° C. under vacuum to obtain the desired compound of formula (1).

5. A process according to claim 4 wherein the compound of formula 3 used is having at least 10% terminal unsaturation and is selected from crystalline and amorphous homopolymers having Mn in the range of 500 to 20,000 and crystalline and amorphous copolymers of C₁-C₈ mono olefins having Mₙ in the range of 500 to 20,000.

6. A process according to claim 4, wherein the compound of formula 3 used is selected from terminally unsaturated poly (propylene), terminally unsaturated poly (hexene1) and copolymer of ethylene and polypropylene.

7. A process according to claim 4, wherein the compound of formula 3 used is selected from terminally unsaturated poly (propylene) having the number average molecular weight (Mn) of 1500 and unsaturated poly (propylene) having the number average molecular weight (Mn) of 2200.

8. A process according to claim 4, wherein the compound of formula 2 used is selected from epoxy end functionalized crystalline and amorphous homopolymers having Mn in the range of 500 to 20,000 and epoxy end functionalized crystalline and amorphous copolymers of C₂ to C₈ mono olefins having Mₙ in the range of 500 to 20,000.

9. A process according to claim 4, wherein the compound of formula 2 used is selected from epoxy end functionalized polypropylene and epoxy end functionalized poly (hexene1) and epoxy end functionalized copolymer of ethylene and polypropylene.

10. A process according to claim 4, wherein the compound of formula 2 used is selected from epoxy end functionalized polypropylene having Mn 1500 and epoxy end functionalized polypropylene having Mn 2200.

11. A process according to claim 4, wherein the organic solvent used in the conversion of the compound of formula 2 to compound of formula 3 is chloroform.

12. A process according to claim 4, wherein the hindered amine light stabilizer of formula 4 used is 4-amino-2,2,6,6-tetramethyl piperidine.

13. A process according to claim 1, wherein the organic solvent used in the reaction of the compound of formula 2 with a HALS compound of formula 4 is selected from the group consisting of hydrocarbon and halogenated hydrocarbon.

14. A process according to claim 13, wherein the organic solvent used in the reaction of the compound of formula 2 with a HALS compound of formula 4 is selected from the group consisting of hexane, heptane, and p-chlorobenzene.

15. A process according to claim 12, wherein the poly hindered amine light stabilizer obtained is selected from 4-amino-2,2,6,6-tetramethyl piperidine end functionalized polypropylene and 4-amino-2,2,6,6-tetramethyl piperidine end functionalized poly (hexene1).

16. A process according to claim 15, wherein the poly hindered amine light stabilizer obtained is selected from N-(2-hydroxypoly (propenyl)-(2,2,6,6-tetramethyl piperidinyl) amine having Mw1500 and N-(2-hydroxypoly(propenyl)-(2,2,6,6-tetramethyl piperidinyl) amine having Mw 2200.
